(19) United States
(12) Patent Application Publication
(10) Pub. No.: US 2011/0110640 A1
(43) Pub. Date: May 12, 2011

(54) OPTICAL COMMUNICATION MODULE, OPTICAL FIBER SUPPORT FIXTURE, AND OPTICAL FIBER WIRING METHOD

(76) Inventors: Fumitoshi GOTO, Yokohama (JP); Toshikazu Otake, Yokohama (JP); Koichi Omori, Yokohama (JP); Kazutaka Nagoya, Kawasaki (JP); Kouhei Sagara, Yokohama (JP)

(21) Appl. No.: 12/943,144

(22) Filed: Nov. 10, 2010

(30) Foreign Application Priority Data
Nov. 11, 2009 (JP) JP 2009-258343

(51) Int. Cl. G02B 6/00; B23P 11/00

(52) U.S. Cl. 385/137; 29/433

(57) ABSTRACT

Provided are an optical communication module which are capable of reducing a risk that an optical fiber may be detached from the optical fiber support fixture. The optical fiber support fixture includes a cylindrical body portion in which a through hole allowing an optical fiber to pass therethrough is formed. The cylindrical body portion has a circumferential surface portion in which a gap that the optical fiber crosses at a time of allowing the optical fiber to pass through the through hole is formed. The cylindrical body portion has an arbitrary point and another point on a center axis of the cylindrical body portion, the arbitrary point and the another point having different positional correspondence relationships with the gap on planes perpendicular to the center axis passing through the arbitrary point and the another point.

### CROSS-REFERENCE TO RELATED APPLICATIONS

The present application claims priority from Japanese application JP 2009-258343 filed on Nov. 11, 2009, the content of which is hereby incorporated by reference into this application.

### BACKGROUND OF THE INVENTION

1. Field of the Invention

The present invention relates to an optical communication module, an optical fiber support fixture, and an optical fiber wiring method.

2. Description of the Related Art

On an optical communication module, a plurality of high frequency optical components which perform optical signal transmission are mounted. Optical fibers connect these optical components to one another, and connect the optical components to external devices. Further, there are optical fiber support fixtures for holding a wiring route of the optical fibers as described above. The optical fiber support fixtures are arranged in the optical communication module.

FIG. 12 is a perspective view illustrating an example of a conventional optical fiber support fixture 102 arranged in the optical communication module. FIG. 13 is a side view of the optical fiber support fixture 102 illustrated in FIG. 12. As illustrated in FIG. 12, the optical fiber support fixture 102 is arranged, for example, on a board 111 mounted on the optical communication module. Then, an optical fiber 103 is allowed to pass through a gap 123 formed between the optical fiber support fixture 102 and the board 111, thereby allowing the optical fiber 103 to pass through a space surrounded by the optical fiber support fixture 102 and the board 111.

The optical fiber support fixture 102 illustrated in FIG. 12 is formed by bending a metal plate. Further, the optical fiber support fixture 102 illustrated in FIG. 12 includes: a plate-like left end portion 126a fixed to the board 111 by soldering; a left inclined portion 126b extended from the left end portion 126a in a direction obliquely upward with respect to the board 111; a plate-like center portion 126c extended from the left inclined portion 126b in a direction along the board 111; a plate-like right inclined portion 126d extended from the center portion 126c in a direction obliquely downward; and a plate-like right end portion 126e extended from the right inclined portion 126d in the direction along the board 111. The center portion 126c is arranged so that a vertical position thereof from the board 111 can be higher than those of the left end portion 126a and the right end portion 126e from the board 111.

In the optical fiber support fixture 102 illustrated in FIG. 12, a length of the left inclined portion 126b, which ranges from a right end of the left end portion 126a to a left end of the center portion 126c, is longer than a length of the right inclined portion 126d, which ranges from a right end of the center portion 126c to a left end of the right end portion 126e. Accordingly, a gap 123 is formed between the right end portion 126e and the board 111. An operator who arranges the optical fiber 103 allows the optical fiber 103 to pass through the gap 123, and arranges the optical fiber 103 in such a space surrounded by the left inclined portion 126b, center portion 126c, and right inclined portion 126d of the optical fiber support fixture 102 and by the board 111 of the optical communication module.

FIG. 14 is a view illustrating an example of a state in which the optical fiber 103 is allowed to pass through the optical fiber support fixtures 102 illustrated in FIG. 12. As illustrated in FIG. 14, the optical fiber 103 is inserted into the optical fiber support fixtures 102 from sides thereof, and is thereby arranged in the optical communication module in a manner of passing under the optical fiber support fixtures 102. In such a way, the wiring route of the optical fiber 103 in the optical communication module can be held by the optical fiber support fixtures 102 illustrated in FIG. 12.

Note that, JP 11-284290 A describes a technology regarding a holding method of latching a flat cable onto a latch piece of a printed board.

### SUMMARY OF THE INVENTION

In such a conventional optical fiber support fixture 102 as illustrated in FIG. 12, there has been a risk that, at the time when the optical fiber 103 moves in a direction perpendicular to an extended direction thereof, the optical fiber 103 may be detached from the optical fiber support fixture 102 through the gap 123 between the right end portion 126e and the board 111.

The present invention has been made in view of the above-mentioned problem. It is an object of the present invention to provide an optical communication module, an optical fiber support fixture, and an optical fiber wiring method, which are capable of reducing a risk that an optical fiber may be detached from the optical fiber support fixture.

In order to solve the above-mentioned problem, an optical communication module according to the present invention includes an optical fiber support fixture arranged in a housing, in which: the optical fiber support fixture includes a cylindrical body port ion in which a through hole allowing an optical fiber to pass therethrough is formed; the cylindrical body portion has a circumferential surface portion in which a gap that the optical fiber crosses at a time of allowing the optical fiber to pass through the through hole is formed; and the cylindrical body portion has an arbitrary point and another point on a center axis of the cylindrical body portion, the arbitrary point and the another point having different positional correspondence relationships with the gap on planes perpendicular to the center axis passing through the arbitrary point and the another point.

Further, an optical fiber support fixture according to the present invention includes a cylindrical body portion in which a through hole allowing an optical fiber to pass therethrough is formed, in which: the cylindrical body portion has a circumferential surface portion in which a gap that the optical fiber crosses at a time of allowing the optical fiber to pass through the through hole is formed; and the cylindrical body portion has an arbitrary point and another point on a center axis of the cylindrical body portion, the arbitrary point and the another point having different positional correspondence relationships with the gap on planes perpendicular to the center axis passing through the arbitrary point and the another point.

In accordance with the present invention, even if the optical fiber moves in a direction perpendicular to an extended direction of the optical fiber at the time when the optical fiber is arranged along the center axis of the cylindrical body portion, the optical fiber is caught on the circumferential surface portion of the cylindrical body portion. Accordingly, it is possible to reduce the risk that the optical fiber may be detached from the optical fiber support fixture.

According to an aspect of the present invention, the optical fiber support fixture is arranged on a surface on which the optical fiber support fixture is arranged so that a direction of the surface and the center axis of the cylindrical body portion can correspond to each other, and that the gap can be oriented in a direction separating from the surface. In accordance with this aspect, the number of steps for wiring the optical fiber can be reduced.

Further, according to an aspect of the present invention, the cylindrical body portion has a first opening portion formed in a bottom surface portion thereof, the first opening portion allowing the through hole and an outside to communicate with each other, and allowing a fixing member fixing the optical fiber support fixture to pass therethrough. In accordance with this aspect, labor for providing such an opening portion in the optical fiber support fixture can be saved at the time of allowing the fixing member to pass through the optical fiber support fixture.

In this aspect, the cylindrical body portion may have a second opening portion formed at a position opposite to a position of the first opening portion, the second opening portion allowing the through hole and the outside to communicate with each other, and allowing a tool for passing the fixing member through the first opening portion to be inserted therethrough. In such a way, it becomes easy to allow the fixing member to pass through the first opening portion.

Further, according to an aspect of the present invention, a length of a part of the cylindrical body portion in a direction along the center axis is shorter than a length of another part of the cylindrical body portion in the direction along the center axis. In accordance with this aspect, the optical fiber support fixture can be bent easily.

In this aspect, the cylindrical body portion may be formed by bending the part of the cylindrical body portion to the center axis side. In such a way, it is possible to further reduce the risk that the optical fiber may be detached from the optical fiber support fixture.

According to an aspect of the present invention, the gap is formed in the cylindrical body portion along a straight line. In accordance with this aspect, it becomes easy to allow the optical fiber to pass through the gap.

Further, according to an aspect of the present invention, a straight line in a vertical direction, the straight line passing through a gravitational center of the cylindrical body portion, intersects a region where the optical fiber support fixture and a surface on which the optical fiber support fixture is arranged contact each other. In accordance with this aspect, it is possible to reduce a risk that the optical fiber support fixture may fall down.

Further, an optical fiber wiring method according to the present invention includes: with regard to an optical fiber support fixture including a cylindrical body portion in which a through hole allowing an optical fiber to pass therethrough is formed, in which the cylindrical body portion has a circumferential surface portion in which a gap that the optical fiber crosses at a time of allowing the optical fiber to pass through the through hole is formed, and the cylindrical body portion has an arbitrary point and another point on a center axis of the cylindrical body portion, the arbitrary point and the another point having different positional correspondence relationships with the gap on planes perpendicular to the center axis passing through the arbitrary point and the another point, arranging the optical fiber support fixture on an arrangement target surface thereof so that a direction of the arrangement target surface and a direction of the center axis of the cylindrical body portion can correspond to each other, and that the gap can be oriented in a direction separating from the arrangement target surface; and passing the optical fiber through the gap, thereby allowing the optical fiber to pass through the through hole.

### BRIEF DESCRIPTION OF THE DRAWINGS

In the accompanying drawings:

FIG. 1 is a schematic appearance view illustrating a schematic example of a state in which optical fiber support fixtures and optical fibers are arranged in an optical communication module according to an embodiment of the present invention;

FIG. 2 is a perspective view illustrating an example of an optical fiber support fixture in the embodiment of the present invention;

FIG. 3 is a cross-sectional view of the optical fiber support fixture illustrated in FIG. 2, taken along a line III-III;

FIG. 4 is a cross-sectional view of the optical fiber support fixture illustrated in FIG. 2, taken along a line IV-IV;

FIG. 5 is a flowchart illustrating an example of a process for wiring the optical fibers in the optical communication module according to the embodiment of the present invention;

FIG. 6 is a view illustrating an example of a state in which the optical fiber is arranged through a through hole of the optical fiber support fixture according to the embodiment of the present invention;

FIG. 7 is a view illustrating an example of a state in which the optical fiber passes through a gap of the optical fiber support fixture according to the embodiment of the present invention;

FIG. 8 is a view illustrating an example of a state in which the optical fiber is allowed to pass through the optical fiber support fixtures according to the embodiment of the present invention;

FIG. 9 is a view illustrating an example of a state in which a circumferential surface of the optical fiber support fixture according to the embodiment of the present invention is bent;

FIG. 10 is a perspective view illustrating an example of an optical fiber support fixture according to another embodiment of the present invention;

FIG. 11 is a perspective view illustrating an example of an optical fiber support fixture according to still another embodiment of the present invention;

FIG. 12 is a perspective view illustrating an example of a conventional optical fiber support fixture;

FIG. 13 is a side view illustrating the example of the conventional optical fiber support fixture, which is illustrated in FIG. 12; and

FIG. 14 is a view illustrating an example of a state in which an optical fiber is allowed to pass through the conventional optical fiber support fixtures, each of which is illustrated in FIG. 12.

### DETAILED DESCRIPTION OF THE INVENTION

A description is made blow in detail of an embodiment of the present invention based on the drawings.

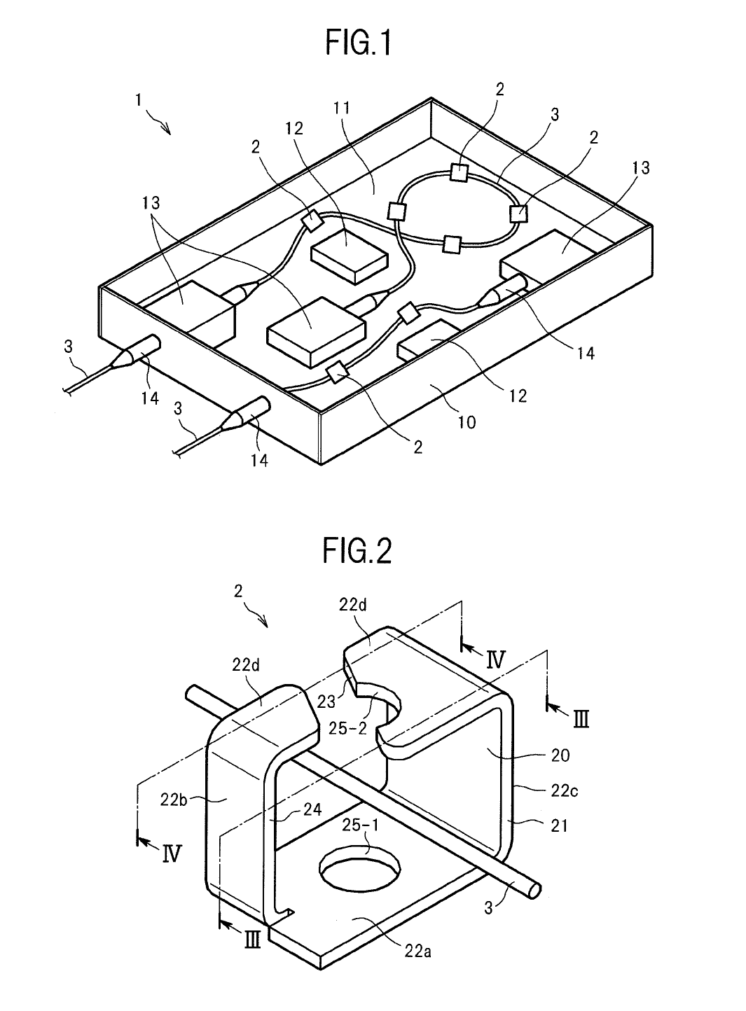

FIG. 1 is a schematic appearance view illustrating a schematic example of a state in which optical fiber support fixtures 2 and optical fibers 3 are arranged in an optical communication module 1 according to this embodiment. FIG. 1 illustrates a state in which a housing 10 of the optical communication module 1 is not closed.

In the optical communication module 1 illustrated in FIG. 1, a board 11 (for example, printed board) is arranged on a bottom surface of the housing 10, and hence the board 11 is housed in the housing 10. The optical fiber support fixtures 2, components 12 which perform signal processing, and the like are mounted on the board 11. Further, holes are formed in the board 11, and high frequency optical components 13 are fitted into the holes. The high frequency optical components 13 are fixed to the bottom surface of the housing 10 of the optical communication module 1 by being screwed thereto.

On side surfaces of the housing 10 and high frequency optical components 13 of the optical communication module 1, connector portions 14 for connecting the optical fibers 3 thereto are provided. Each of the connector portions 14 illustrated in FIG. 1 has a substantially cylindrical shape tapered so that a tip end thereof can be thin. In the housing 10, the high frequency optical components 13 are connected to one another by the optical fibers 3. Specifically, in the housing 10, the optical fibers 3 for connecting the high frequency optical components 13 to one another are wired. In the housing 10, the optical fibers 3 are wired so as to pass through positions where the optical fiber support fixtures 2 are arranged. Further, the optical fibers 3 are wired to an outside of the housing 10 via the connector portions 14 provided on the side surface of the housing 10 of the optical communication module 1. In such a way, the optical communication module 1 can perform optical signal communication with the outside. Note that, on a back surface of the housing 10, an externally connecting high frequency connector (not shown) for performing electric signal communication with the outside is provided.

As described above, in the optical communication module 1 according to this embodiment, the optical fibers 3 are allowed to pass through the optical fiber support fixtures 2, and hence a wiring route of the optical fibers 3 is held so as to prevent the optical fibers 3 from being caught between a cover of the housing 10 and the high frequency optical components 13, and to prevent a curvature radius of the optical fibers 3 from becoming smaller than a value in a component specification.

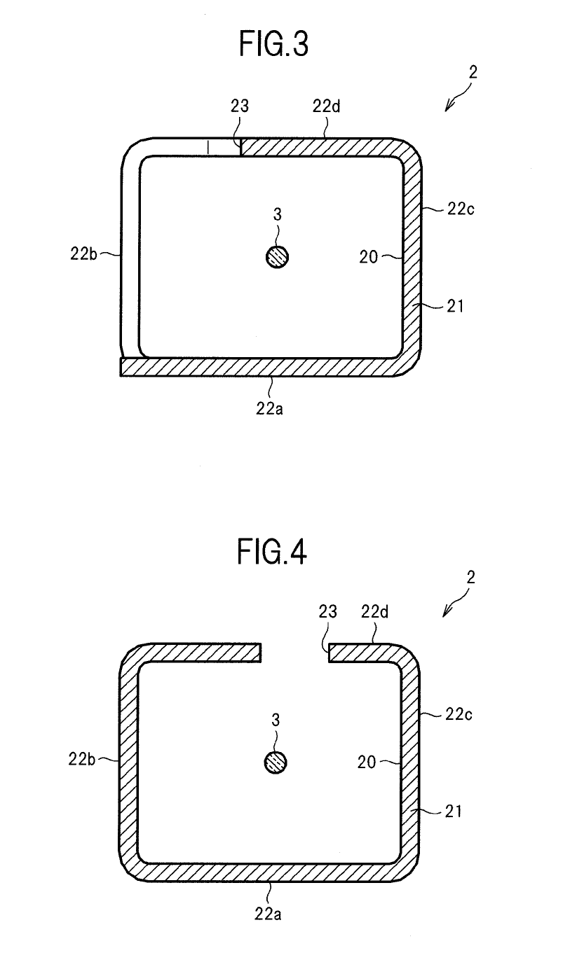

FIG. 2 is a perspective view illustrating an example of the optical fiber support fixture 2 according to this embodiment. FIG. 3 is a cross-sectional view of the optical fiber support fixture 2 illustrated in FIG. 2, taken along a line III-III. FIG. 4 is a cross-sectional view of the optical fiber support fixture 2 illustrated in FIG. 2, taken along a line IV-IV. As illustrated in FIG. 2, the optical fiber support fixture 2 according to this embodiment includes a body portion 21 in which a through hole 20 penetrating the body portion 21 from a front side to a depth side is formed. The body portion 21 has a substantially quadrangular cross-sectional shape in which corners are round. Further, the body portion 21 has a laterally oriented cylindrical shape in which a center axis corresponds to a direction of an upper surface of the board 11 (for example, goes along the direction of the upper surface of the board 11). As illustrated in FIG. 2, the optical fiber 3 is arranged along the center axis of the body portion 21 of the optical fiber support fixture 2. Both of cross sections taken along the line III-III and the line IV-IV are planes perpendicular to the center axis of the body portion 21.

The body portion 21 of the optical fiber support fixture 2 is composed by including four circumferential surface portions 22 (bottom surface portion 22a, left surface portion 22b, right surface portion 22c, and upper surface portion 22d). The bottom surface portion 22a contacts the upper surface of the board 11 on which the optical fiber support fixture 2 is arranged. The left surface portion 22b is extended upward in the vertical direction, and a lower edge of the left surface portion 22b is connected to a left edge of the bottom surface portion 22a when viewed in a direction from the front toward the depth in FIG. 2. The right surface portion 22c is also extended upward in the vertical direction, and a lower edge of the right side portion 22c is connected to a right edge of the bottom surface portion 22a when viewed in the direction from the front to the depth in FIG. 2.

The upper surface portion 22d is extended in the direction along the upper surface of the board 11. A left edge of the upper surface portion 22d is connected to an upper edge of the left surface portion 22b, and a right edge of the upper surface portion 22d is connected to an upper edge of the right surface portion 22c.

In the upper surface portion 22d, a gap 23 is formed, which is crossed by the optical fiber 3 at the time of allowing the optical fiber 3 to pass through the through hole 20 of the optical fiber support fixture 2. In the example of FIG. 2, the gap 23 as a cut with a width approximately ranging from 0.3 mm to 3 mm is formed in the upper surface portion 22d. As described above, the optical fiber support fixture 2 according to this embodiment is arranged on the board 11 so that the gap 23 can be oriented in a direction separating from the upper surface of the board 11. Further, in the optical fiber support fixture 2 according to this embodiment, the gap 23 is arranged along a straight line in the upper surface portion 22d so that an angle made by an extended direction of the gap 23 and a plane perpendicular to the center axis of the body portion 21 can range from 15 degrees to 75 degrees.

On the front side in FIG. 2, a notch 24 is formed from the left surface portion 22b to a portion of the upper surface portion 22d, which is more left side than the gap 23. A length of the left surface portion 22b, which is along the center axis of the body portion 21, is shorter than a length of the right surface portion 22c, the bottom surface portion 22a, and a portion of the upper surface portion 22d which is more right side than the gap 23. Here, the length of these portions is also along the center axis of the body portion 21, and the above-mentioned length of the left surface portion 22 approximately ranges, for example, from ¼ to ¾ of the length of these other portions.

On a center of the bottom surface portion 22a, a first opening portion 25-1 is formed, which has a circular cross section and allows the through hole 20 and the outside to communicate with each other. At a position of the upper surface portion 22d, which is opposite to the first opening portion 25-1, a second opening portion 25-2 is formed, which has a circular cross section and allows the through hole 20 and the outside to communicate with each other. Note that, in the optical fiber support fixture 2 illustrated in FIG. 2, a part of a region where the gap 23 is formed and a part of a region where the second opening portion 25-2 is formed are integrated.

The body portion 21 of the optical fiber support fixture 2 illustrated in FIG. 2 is made of metal. In particular, the bottom surface portion 22a is made of flat metal. Of course, the optical fiber support fixture 2 may be made of a material other than metal. Further, in the optical fiber support fixture 2 according to this embodiment, the gap 23, the first opening portion 25-1, the second opening portion 25-2, and the notch 24 of the left surface portion 22b are formed so that an area of the bottom surface portion 22a of the body portion 21 can become approximately 1.05 times or more an area of the upper surface portion 22d of the body portion 21. Here, the area of the upper surface portion 22d is the sum of areas of the respective regions of the upper surface portion 22d of the body portion 21, which interpose the gap 23 therebetween.

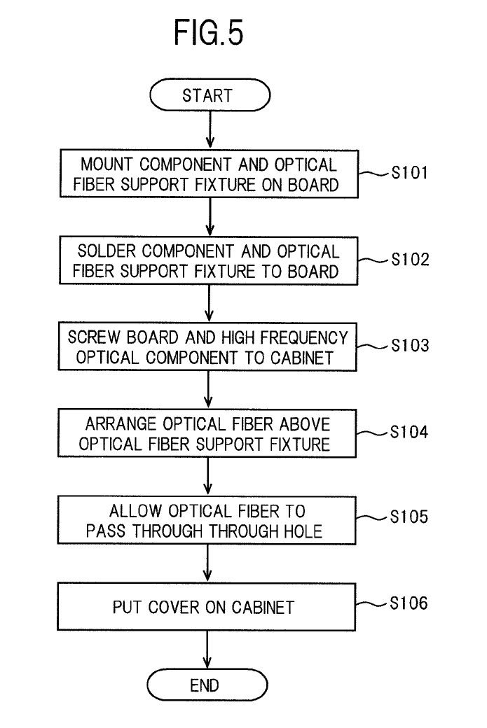

Here, while referring to a flowchart illustrated in FIG. 5, a description is made of an example of a process for wiring the optical fibers 3 in the housing 10 in the optical communication module 1 according to this embodiment.

First, on the board 11, in which holes are formed, and over a surface of which solder paste is applied, the components 12 which perform the signal processing and the optical fiber support fixtures 2 are mounted by an automatic mounter (S101). Then, the components 12 and the optical fiber support fixtures 2 are soldered to the board 11 using a board reflow furnace (S102). Then, the board 11 is screwed to the housing 10, and the high frequency optical components 13 are fitted into the holes formed in the board 11, and are screwed to the housing 10 (S103). Then, the optical fibers 3 are arranged above the optical fiber support fixtures 2 along the wiring route (S104). Then, by being allowed to collectively pass through the gaps 23 of a plurality of the optical fiber support fixtures 2, the optical fibers 3 are allowed to pass through the through holes 20 of the body portions 21 of the optical fiber support fixtures 2 (S105). Then, the cover is put on the housing 10 (S106). In such a way, the optical fibers 3 are wired at predetermined positions in the housing 10.

As illustrated in FIG. 3 and FIG. 4, in each of the optical fiber support fixtures 2 according to this embodiment, a positional relationship is established, where the gap 23 on the cross section taken along the line III-III and the gap 23 on the cross section taken along the line IV-IV do not overlap each other. Further, in the optical fiber support fixture 2 according to this embodiment, for example, a positional relationship is established, where a position of the gap 23 viewed from the front and a position of the gap 23 viewed from the back do not overlap each other when both thereof are viewed in a perspective view from the front. Therefore, even if each of the optical fibers 3 moves in a direction perpendicular to an extended direction of the optical fibers 3 when the optical fiber 3 is arranged along the center axis of the body portion 21, the optical fiber 3 is caught on any of the circumferential surface portions 22.

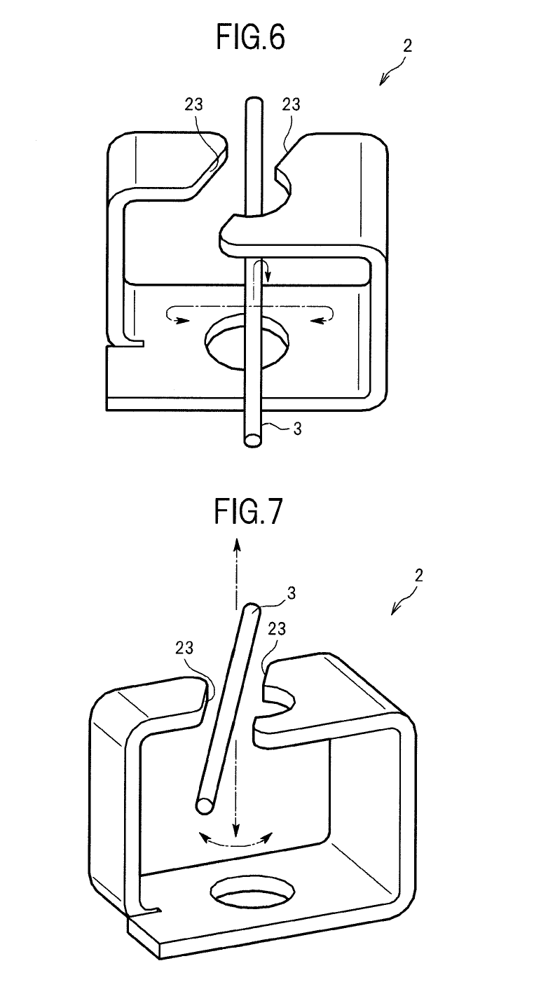

Further, the optical fiber 3 according to this embodiment is coated with an elastic body. Therefore, after the optical fiber 3 is allowed to pass through the through hole 20 of the body portion 21, and the wiring route is determined, as illustrated in FIG. 6, the position of the optical fiber 3 is kept in a space between the bottom surface portion 22a and the upper surface portion 22d by elastic force of the optical fiber 3 itself, and the extended direction of the optical fiber 3 is hardly changed from the direction of the center axis of the body portion 21. In such a way, in the optical fiber support fixture 2 according to this embodiment, such a risk that the optical fiber 3 may be detached from the optical fiber support fixture 2 can be reduced.

Further, as illustrated in FIG. 7, when the optical fiber 3 is extended so as to go along the extended direction of the gap 23, and the optical fiber 3 is moved in a direction perpendicular to the extended direction thereof, the optical fiber 3 can be allowed to cross the gap 23. Accordingly, in the optical fiber support fixture 2 according to this embodiment, it is easy for an operator to pass the optical fiber 3 through the through hole 20, and to detach the optical fiber 3 from the through hole 20.

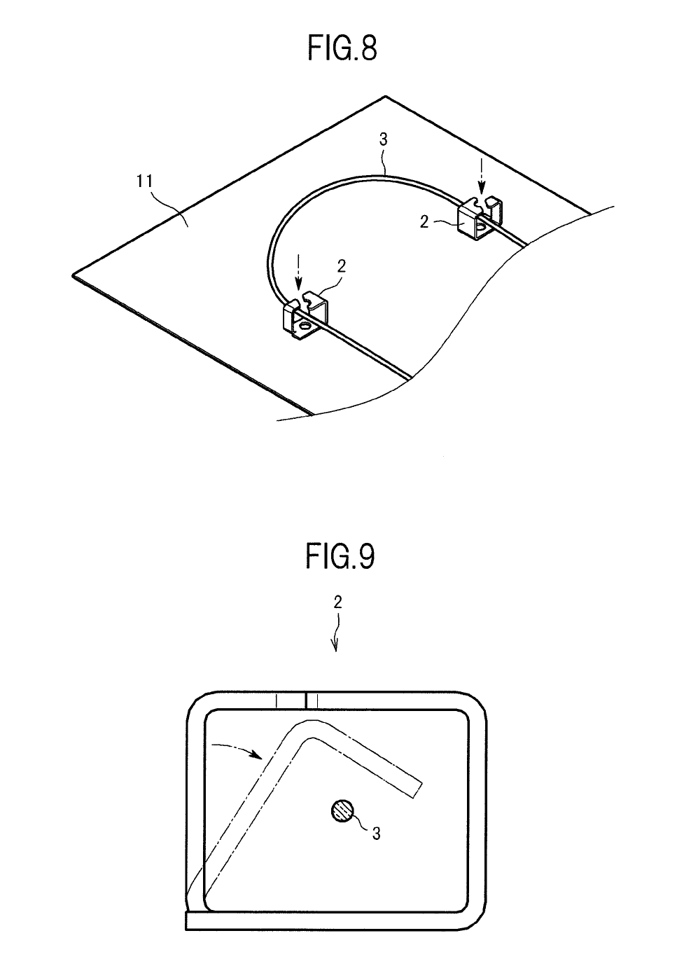

Further, in the optical fiber support fixture 2 according to this embodiment, the gap 23 is formed in the upper surface portion 22d. Accordingly, as illustrated in FIG. 8, the operator can insert the optical fiber 3 into the optical fiber support fixtures 2 from the above, and can pass the optical fiber 3 through the through holes 20 of the body portions 21. Therefore, the optical fiber 3 can be collectively inserted into the plurality of optical fiber support fixtures 2, and the number of assembly steps for the optical communication module 1 can be reduced.

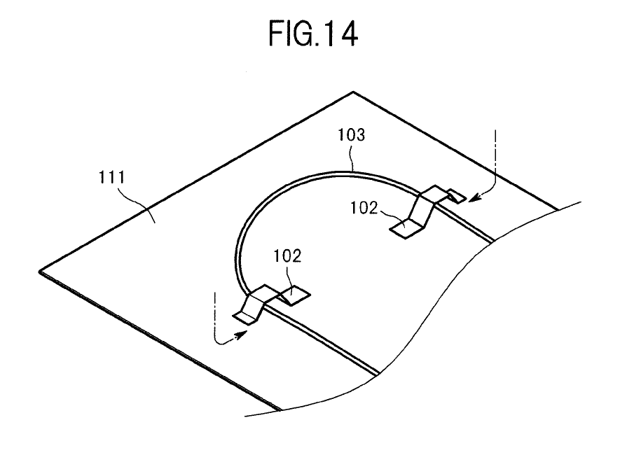

Further, in the conventional optical fiber support fixtures 102, the optical fiber 103 is inserted into the optical fiber support fixtures 102 from the sides thereof. Accordingly, a spot has sometimes occurred, where a curvature radius of the optical fiber 103 becomes small because the optical fiber 103 is pulled in a direction (for example, horizontal direction) along the upper surface of the board 111 (refer to FIG. 14). Further, in order to adjust a wired shape of the optical fiber 103, it has been necessary to positionally align the optical fiber 103 by moving the optical fiber 103 in the direction (for example, horizontal direction) along the upper surface of the board 111. Meanwhile, in the optical communication module 1 in which the optical fiber support fixtures 2 according to this embodiment are arranged, as illustrated in FIG. 8, each of the optical fibers 3 can be allowed to pass through the through holes 20 of the body portions 21 from the above while keeping a wired shape of the optical fiber 3. Therefore, such a risk that the curvature radius of the optical fiber 3 may become small is reduced. Further, it is also possible to reduce the step of adjusting the wiring route of the optical fiber 3 after passing the optical fiber 3 through the through holes 20 of the optical fiber support fixtures 2.

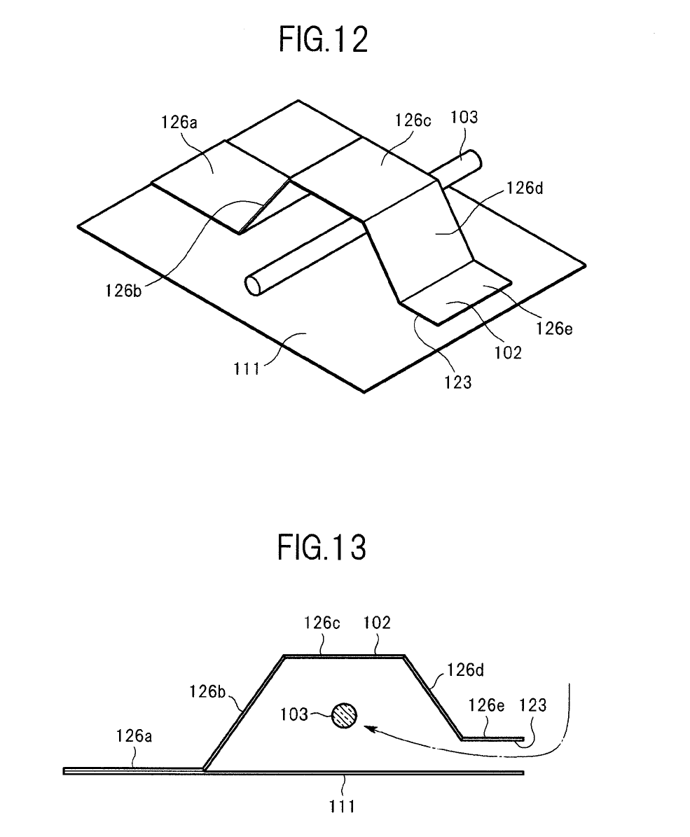

Further, in each of the conventional optical fiber support fixtures 102, the gap between the right end portion 126e and the board 111 is approximately 1.1 times a diameter of the optical fiber 103, and it is necessary to insert the optical fiber 103 into the optical fiber support fixture 102 from the side thereof. Accordingly, it has been difficult for the operator to see a state in which the optical fiber 103 is thus inserted, and the number of steps has been required to positionally align the optical fiber 103 when the optical fiber 103 is inserted (refer to FIG. 12 and FIG. 13). Meanwhile, in the optical communication module 1 including the optical fiber support fixtures 2 according to this embodiment, the optical fiber 3 can be allowed to pass through the through holes 20 of the body portions 21 from the above. Accordingly, it is easy for the operator to see a state in which the optical fiber 3 is thus inserted, it is easy to positionally align the optical fiber 3 when the optical fiber 3 is allowed to pass through the through holes 20 of the body portions 21, and the number of assembly steps for the optical communication module 1 can be reduced.

In each of the optical fiber support fixtures 2 according to this embodiment, the first opening portion 25-1 formed in the body portion 21 can be used as a hole (for example, a screw hole at the time of screwing) allowing a fixing member to pass therethrough. Here, the fixing member serves for fixing the optical fiber support fixture 2 to the board 11 and the housing 10. Further, in the optical fiber support fixture 2 according to this embodiment, at the time of screwing, the second opening portion 25-2 formed in the body portion 21 can be used as a hole for having a tool inserted therethrough. Here, the tool serves for passing the fixing member through the first opening member 25-1 (for example, a screw driver).

In each of the optical fiber support fixtures 2 according to this embodiment, the length of the left surface portion 22b, which is along the center axis of the body portion 21, is shorter than the length of the right surface portion 22c, the bottom surface portion 22a, and the portion of the upper surface portion 22d which is more right side than the gap 23. Here, the length of these portions is also along the center axis of the body portion 21. Accordingly, flexural rigidity of the lower edge of the left surface portion 22b (that is, the left edge of the bottom surface portion 22a) is decreased. Therefore, as illustrated in FIG. 9, the left surface portion 22b and the portion of the upper surface portion 22d which is more left side than the gap 23, can be easily bent to a center axis side of the body portion 21 of the optical fiber support fixture 2 about the lower edge of the left surface portion 22b (that is, the left edge of the bottom surface portion 22a).

In this connection, if the optical fiber support fixture 2 is bent as described above after the optical fiber 3 is inserted into each of the through holes 20 of the body portions 21 and the wiring route is determined, then it is possible to further reduce the risk that the optical fiber 3 may be detached from the optical fiber support fixture 2.

Further, in the optical fiber support fixture 2 according to this embodiment, a straight line in the vertical direction, which passes through a gravitational center of the body portion 21, intersects the bottom surface portion 22a. Therefore, the optical fiber support fixture 2 stably stands, and is less likely to fall down. Further, in the optical fiber support fixture 2 according to this embodiment, the area of the bottom surface portion 22a of the body portion 21 is approximately 1.05 times or more the sum of the areas of the portions of the upper surface portion 22d of the body portion 21, which are more left and right sides of the gap 23, and a position of the gravitational center of the body portion 21 is relatively low. Accordingly, the optical fiber support fixture 2 is more stable. In such a way, it is possible to reduce such a risk that the optical fiber support fixture 2 may fall down at the time of mounting the optical fiber support fixture 2 on the board 11 by the automatic mounter and at the time of soldering the optical fiber support fixture 2 onto the board 11 using the board ref low furnace.

Note that, the present invention is not limited to the above-mentioned embodiment.

For example, both of the lower edge of the left surface portion 22b (that is, the left edge of the bottom surface portion 22a) and the lower edge of the right surface portion 22c (that is, the right edge of the bottom surface portion 22a) may be thinner than other portions. Then, a configuration may be adopted, in which the left surface portion 22b and the portion of the upper surface portion 22d which is more left side than the gap 23, can be bent to the center axis side of the body portion 21 of the optical fiber support fixture 2 about the lower edge of the left surface portion 22b (that is, the left edge of the bottom surface portion 22a), and further, the right surface portion 22c and the portion of the upper surface portion 22d which is more right side than the gap 23, may be bent to the center axis side of the body portion 21 of the optical fiber support fixture 2 about the lower edge of the right surface portion 22c (that is, the right side of the bottom surface portion 22a).

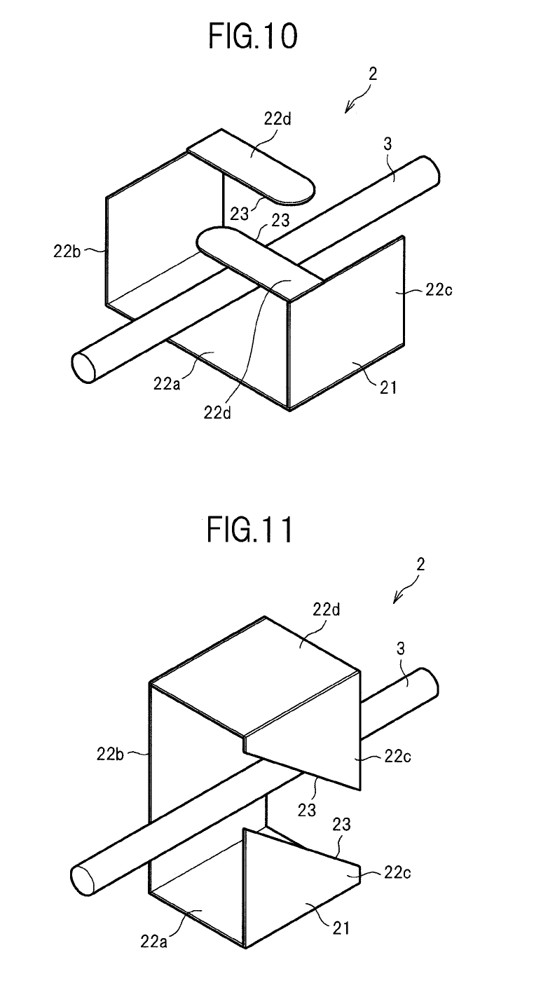

Further, for example, like an optical fiber support fixture 2 illustrated in FIG. 10, the upper surface portion 22d may be composed of two nail-like members, and a meandering gap 23 may be formed therebetween. As described above, in the body portion 21 of the optical fiber support fixture 2, the gap 23 does not have to be formed along a straight line. Further, for example, like an optical fiber support fixture 2 illustrated in FIG. 11, the gap 23 may be formed in a portion of the circumferential surface portions 22, which is other than the upper surface portion 22d. In the example of FIG. 11, such other portion on which the gap 23 is formed is the right surface portion 22c.

Also in each of the optical fiber support fixtures 2 illustrated in FIG. 10 and FIG. 11, an arbitrary point and another point on the center axis of the body portion 21 have different positional correspondence relationships with the gap 23 on the planes perpendicular to the center axis passing through the points. Accordingly, even if the optical fiber 3 moves in the direction perpendicular to the extended direction of the optical fiber 3 at the time when the optical fiber 3 is arranged along the center axis of the body portion 21, the optical fiber 3 is caught on any one of the circumferential surfaces of the body portion 21.

Further, for example, in the optical fiber support fixture 2, even if a length of the body portion in a diameter direction differs depending on the position on the center axis, if an arbitrary point and another point on the center axis of the body portion 21 have different angular ranges of the gap 23 formed in the body portion 21 with respect to a predetermined direction, then the optical fiber 3 is caught on any one of the circumferential surfaces of the body portion 21 even if the optical fiber 3 moves in the direction perpendicular to the extended direction of the optical fiber 3 at the time when the optical fiber 3 is arranged along the center axis of the body portion 21.

Further, as illustrated in FIG. 10 and FIG. 11, the notch 24, the first opening portion 25-1 and the second opening portion 25-2 do not have to be formed in the optical fiber support fixture 2. Further, the cross-sectional shape of the body portion 21 is not limited to that of the above-mentioned optical fiber support fixture 2. For example, the cross-sectional shape of the body portion 21 may be circular.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical communication module, comprising an optical fiber support fixture arranged in a housing, wherein:
the optical fiber support fixture comprises a cylindrical body portion in which a through hole allowing an optical fiber to pass therethrough is formed;
the cylindrical body portion has a circumferential surface portion in which a gap that the optical fiber crosses at a time of allowing the optical fiber to pass through the through hole is formed; and
the cylindrical body portion has an arbitrary point and another point on a center axis of the cylindrical body portion, the arbitrary point and the another point having different positional correspondence relationships with the gap on planes perpendicular to the center axis passing through the arbitrary point and the another point.

2. The optical communication module according to claim 1, wherein the optical fiber support fixture is arranged on a surface on which the optical fiber support fixture is arranged so that a direction of the surface and the center axis of the cylindrical body portion can correspond to each other, and that the gap can be oriented in a direction separating from the surface.

3. The optical communication module according to claim 1, wherein the cylindrical body portion has a first opening portion formed in a bottom surface portion thereof, the first opening portion allowing the through hole and an outside to communicate with each other, and allowing a fixing member fixing the optical fiber support fixture to pass therethrough.

4. The optical communication module according to claim 3, wherein the cylindrical body portion has a second opening portion formed at a position opposite to a position of the first opening portion, the second opening portion allowing the through hole and the outside to communicate with each other, and allowing a tool for passing the fixing member through the first opening portion to be inserted therethrough.

5. The optical communication module according to claim 1, wherein a length of a part of the cylindrical body portion in a direction along the center axis is shorter than a length of another part of the cylindrical body portion in the direction along the center axis.

6. The optical communication module according to claim 5, wherein the cylindrical body portion is formed by bending the part of the cylindrical body portion to the center axis side.

7. The optical communication module according to claim 1, wherein the gap is formed in the cylindrical body portion along a straight line.

8. The optical communication module according to claim 1, wherein a straight line in a vertical direction, the straight line passing through a gravitational center of the cylindrical body portion, intersects a region where the optical fiber support fixture and a surface on which the optical fiber support fixture is arranged contact each other.

9. An optical fiber support fixture, comprising a cylindrical body portion in which a through hole allowing an optical fiber to pass therethrough is formed, wherein:
the cylindrical body portion has a circumferential surface portion in which a gap that the optical fiber crosses at a time of allowing the optical fiber to pass through the through hole is formed; and
the cylindrical body portion has an arbitrary point and another point on a center axis of the cylindrical body portion, the arbitrary point and the another point having different positional correspondence relationships with the gap on planes perpendicular to the center axis passing through the arbitrary point and the another point.

10. An optical fiber wiring method, comprising:
with regard to an optical fiber support fixture including a cylindrical body portion in which a through hole allowing an optical fiber to pass therethrough is formed, in which the cylindrical body portion has a circumferential surface portion in which a gap that the optical fiber crosses at a time of allowing the optical fiber to pass through the through hole is formed, and the cylindrical body portion has an arbitrary point and another point on a center axis of the cylindrical body portion, the arbitrary point and the another point having different positional correspondence relationships with the gap on planes perpendicular to the center axis passing through the arbitrary point and the another point, arranging the optical fiber support fixture on an arrangement target surface thereof so that a direction of the arrangement target surface and a direction of the center axis of the cylindrical body portion can correspond to each other, and that the gap can be oriented in a direction separating from the arrangement target surface; and
passing the optical fiber through the gap, thereby allowing the optical fiber to pass through the through hole.
